(19) United States
(12) Patent Application Publication
(10) Pub. No.: US 2012/0144299 A1
(43) Pub. Date: Jun. 7, 2012

(54) Blind Navigation for Touch Interfaces

(75) Inventors: Sneha Patel, Romanel Sur Morges (CH); Ian Crowe, Romanel Sur Morges (CH); Steve Gervais, Newmarket (CA)

(73) Assignee: Logitech Europe S.A., Morges (CH)

(21) Appl. No.: 13/248,124

(22) Filed: Sep. 29, 2011

Related U.S. Application Data
(60) Provisional application No. 61/388,521, filed on Sep. 30, 2010.

(51) Int. Cl. G06F 3/048

(52) U.S. Cl. 715/702; 715/778; 715/863

(57) ABSTRACT

Systems and methods for enabling blind navigation of a control device having a touch interface include one or more steps of receiving an indication that the control device is to enable blind navigation, receiving an input via the touch interface, determining a command to which the received input corresponds, and executing or transmitting the command.

### CROSS-REFERENCES TO RELATED APPLICATIONS

This application is a non-provisional of, and claims priority to, U.S. Provisional Patent Application No. 61/388,521, filed 30 Sep. 2010, titled “BLIND NAVIGATION FOR TOUCH INTERFACES”, of Sneha Patel et al., and which is incorporated by reference herein in its entirety for all purposes.

### BACKGROUND OF THE INVENTION

The present invention generally relates to control devices with touch screens, such as smart phones, embedded and/or remote controls for controlling appliances, etc. More specifically, several embodiments of the present invention relate to systems and methods including “blind navigation” of a device with a touch interface and a display.

It is becoming increasingly common for control devices to include touch interfaces in addition to, or instead of, more conventional user input elements, such as buttons, sliders, joysticks, etc. Examples of control devices include smartphones (e.g., an iPhone™ of Apple Inc., Cupertino Calif.), remote controls, mice, keyboards, webcams, cameras, listening devices, tablets (e.g., an iPad™ of Apple, Inc., Cupertino Calif.), to name just a few. Many control devices are also used for various purposes in addition to controlling the particular device that the controller is attached to. For instance, a touch interface included in an iPhone™ or an iPad™ may be used as a control device for the phone and as a remote control for appliances, such as entertainment devices. Entertainment devices may include TVs, DVRs, receivers, etc. An entertainment device might also be a computer or gaming console (e.g., a Sony® PlayStation 3™, Nintendo® DS™, or Microsoft Xbox 360®) operating a media application, such as iTunes™ where the control device is configured to control iTunes™ (e.g., volume up/down, media selection, etc.) by controlling the computer.

Touch interfaces are based on various technologies, such as resistive touch pads, capacitive touch pads, optical touch pads, etc. Touch interfaces have several advantages over other types of user interfaces. For instance, touch interfaces have fewer moving parts, which may break over time, and fewer possibilities for dust/dirt contamination, to name just a few advantages. Additionally, touch interfaces are sleek and smooth looking.

However, one of the disadvantages of touch interfaces is that they do not allow for blind navigation. Blind navigation includes use by a user of a control device without looking at the control device. With user input elements, such as buttons, switches, and sliders, users receive tactile feedback from touching these user input elements and can often be guided by the shape, the feel, the location, the mechanical action, etc. of these user input elements to effectively use different user input elements without looking at them. This is often very desirable, in particular because the user need not divert his/her attention from the task at hand (e.g., watching a movie) to look at the control device to perform a desired task (e.g., increase the volume). Further, it is possible to operate such control devices in a dark or low-lighting environment via blind navigation.

In contrast, touch interfaces are, as mentioned above, smooth and sleek, and are not amenable to such blind navigation. Users are thus currently forced to divert their attention from the task at hand to look at the control device, and then perform the desired task on the touch interface. Further, operating touch interfaces in the dark or in low-light conditions is problematic.

Hence, there exist ongoing needs for apparatus, systems, and methods that provide for blind navigation of a control device which includes a touch interface.

### BRIEF SUMMARY OF THE INVENTION

The present invention generally relates to control devices with touch screens, such as smart phones, embedded and/or remote controls for controlling appliances, etc. More specifically, several embodiments of the present invention relate to systems and methods including “blind navigation” of a device with a touch interface.

According to first aspects of the invention, in systems and methods where a first control interface is presented to a user, the first control interface may be configured to respond to touch inputs in designated areas of a touch interface, e.g. areas of a touch screen with various icons representing software applications, designated functions, control commands, numbers, etc. Embodiments may include receiving a command to change the first control interface to a second control interface in which the touch screen is responsive to, for example, touch patterns, swipes, or other pre-designated touch locations that correspond to a “blind interface” that do not require the user to look at the touch screen in order to operate the controller.

In embodiments, systems and methods may provide, for example, when a software application is active on a device, such as a smartphone, remote control, etc., the software application may be configured to receive an input from a user to change an operation mode, such as turning on a blind navigation mode. One example of such an indication that the device is configured to receive for changing a mode of operation is a relatively quick shake of the device. For example, if the device is relatively quickly shaken, the software application thereafter enters the blind navigation mode. Pre-determined gestures/swipes on the touch interface may be recognized by the touch interface and the software application as specific commands (e.g., channel up/down, volume up/down, change TV input, etc.).

In embodiments, a device in accordance with aspects of the present invention may have a first mode in which a graphical interface is used, and a second mode in which a blind-navigation user interface is used. In one such embodiment, the blind navigation user interface may be based on gestures (e.g., moving the device up, down, an/or rotating or tilting the device), swipes on the touch interface, or a combination of these. In one embodiment, the device may be configured to switch from one mode to the other upon receiving an indication from the user (e.g., a programmed tactile button, a quick shake of the device, activation of a particular element of the graphical user interface, a particular gesture, etc.).

Embodiments may include a computer-implemented method of enabling blind navigation of a control device having a touch display interface, including one or more steps of presenting a first user interface on the touch display interface, the first user interface including an icon selectable by touching a designated portion of the touch display interface; receiving an indication that the control device is to enable a second user interface; reconfiguring the touch display interface to receive a set of commands, corresponding to the second user interface, including one or more touch movements on the touch display interface; receiving a touch movement input via the touch display interface; determining a command, from among the set of commands, to which the received touch movement input corresponds; and/or at least one of executing and transmitting the command.

In embodiments, the first user interface may include one or more commands responsive to touch movements on a touch interface, such as the touch display interface or a non-display touch interface. When the first user interface includes one or more commands responsive to touch movements on a touch interface, the first user interface may, or may not, include icons. The touch movement commands of the first user interface may include one or more different commands and/or gestures than the second user interface. For example, a particular command may have a first touch gesture in the first user interface, and a second touch gesture in the second user interface that is different than the first gesture. By way of further example, a first command in the first user interface may have a first touch gesture, and a different command in the second user interface may use the first gesture, e.g. a screen swipe in the first user interface may instruct a pointer movement or page turn command, and the same page swipe in the second user interface may be used to issue a command to an application or peripheral device, such as volume control, channel change, etc.

In embodiments, the control device may be, for example, a smartphone, a universal remote control, a tablet computer, a keyboard with a touch interface such as the Logitech Revue™, etc.

In embodiments, the command may be transmitted by the control device to a separate appliance, via, for example, IR, RF or other communication link. In an embodiment of the invention, an IR gateway, such as the Logitech Harmony® Link, received the command from the device with the touch interface, via for example a wireless computer network, and sends an infrared command to the targeted device. In embodiments, the command is transmitted to, for example, an entertainment device. In an embodiment of the invention, a number of devices are connected via wired and/or wireless links, and enabled to transmit commands to each other. In embodiments, commands intended for a first device may be sent from a control device to a second device, and the second device may transmit the command to the first device. For example an amplifier and a DVD player may be connected to each other via a link such as Denon Link®, and a command for the DVD player may be transmitted by a control device to the amplifier, and the amplifier may forward the command to the DVD player.

In embodiments, the command may be transmitted via a network.

In embodiments, the indication that the control device is to enable a second user interface may be provided by an ambient source, such as, for example, an ambient light, a short-range communication link and/or signal, etc.

In embodiments, the step of determining a command to which the received touch movement input corresponds may include comparing the received touch movement input to a plurality of pre-specified inputs, wherein each of the plurality of pre-specified inputs is mapped to a command.

In embodiments, reconfiguring the touch screen interface may include disabling a portion of the first user interface, such as the icon. Embodiments may include enabling a touch movement command in the second user interface that corresponds to a command function of the disabled portion of the first user interface. For example, one or more volume control icons in the first user interface may be disabled and their command functions replicated by one or more touch movement commands in the second user interface. In embodiments, reconfiguring the touch screen interface may include enabling a portion of the touch display interface to respond to touch movement commands in the second user interface.

In embodiments, the step of receiving an indication that the control device is to enable the second user interface may include receiving a predetermined input based on information from one or more of a tilt, motion and orientation of the control device. In embodiments, the step of receiving an indication that the control device is to enable the second user interface may include receiving a shaking motion of the control device. In embodiments, the step of receiving an indication that the control device is to enable the second user interface may include receiving an input from at least one of an icon, a push button and a touch interface.

In embodiments, a user feedback may also be provided based on the determining of the command to which the received touch movement input corresponds. In embodiments, the user feedback may include at least one of a device vibration, an audio signal, and a visual signal. In embodiments, the user feedback may indicate the determined command in a manner that is distinguishable from other possible commands.

According to further aspects of the invention, a control device may be provided including a touch display interface; a microprocessor; and computer-readable storage medium. The computer-readable storage medium may include program instructions executable by the microprocessor, which configure the microprocessor to perform various functions including one or more of, present a first user interface on the touch display interface, the first user interface including an icon selectable by touching a designated portion of the touch display interface; receive an indication that the control device is to enable a second user interface; reconfigure the touch display interface to receive a set of commands, corresponding to the second user interface, including one or more touch movements on the touch display interface; receive a touch movement input via the touch display interface; determine a command, from among the set of commands, to which the received touch movement input corresponds; and/or at least one of execute and transmit the command. In an embodiment of the invention, a touch-pad or other device without a touch display may be used, such as a trackpad or other non-display touch interface.

In embodiments, the control device is included in a smartphone. In embodiments, the second user interface may include commands for controlling the smartphone, or other device, that includes the control device. In other embodiments, the control device may be included in a tablet computer such as the Amazon Kindle® Fire, or an Apple iPod™ Touch.

In embodiments, the device may be configured to provide a user feedback based on the determining of the command to which the received touch movement input corresponds. In embodiments, the user feedback may indicate the determined command in a manner that is distinguishable from other possible commands.

According to further aspects of the invention, a computer-implemented method of enabling blind navigation of a control device having a touch interface, and at least one of a tilt sensor, an orientation sensor, and a motion sensor, may include one or more steps of enabling a first user interface on the control device, the first user interface including a first set of commands that can be activated by touching the touch interface; receiving an indication via at least one of the tilt sensor, the orientation sensor and the motion sensor that the control device is to enable a second user interface wherein the second user interface includes a second set of commands configured to be receptive to at least one touch gesture on the touch interface; enabling the second user interface; receiving a touch gesture input via the touch interface; determining a command, from among the second set of commands, to which the received touch gesture input corresponds; and/or at least one of executing and transmitting the command.

In embodiments, the indication may be received via a plurality of orientation sensors and/or a plurality of tilt sensors. Such sensors may include, for example, an accelerometer and/or a gyroscope.

In embodiments, the indication may be a gesture through which the control device is moved. In embodiments, the indication may be a gesture detected by the motion detector. In embodiments, the indication may be a shake of the control device.

In embodiments, a particular movement of the device that initiates the indication may be set by a user.

In embodiments, the first user interface may include a command gesture that performs a selected function included in both of the first user interface and the second user interface, using a different gesture than the second user interface uses for the first selected function. In embodiments, the first user interface may include a command gesture that performs a selected function of the first user interface, using a same gesture that is also used by the second user interface for a different function than the selected function.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention claimed. The detailed description and the specific examples, however, indicate only preferred embodiments of the invention. Various changes and modifications within the spirit and scope of the invention will become apparent to those skilled in the art from this detailed description.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and various ways in which it may be practiced. In the drawings:

FIG. 1 is a simplified schematic of a control device configured to control a set of appliances according to one embodiment of the present invention;

FIG. 2 is a simplified schematic of an electronic circuit that may be included in a control device according to aspects of the invention;

FIG. 3 is a high-level flow chart for a method for changing a mode of operation of a control device according to one embodiment of the present invention;

FIG. 4 is a simplified schematic of another electronic circuit that may be included in the smartphone;

FIG. 5 shows an exemplary blind navigation interface being activated and instructions displayed in the blind navigation interface; and

FIG. 6 is a flow chart for a method of an embodiment of the invention.

### DETAILED DESCRIPTION OF THE INVENTION

It is understood that the invention is not limited to the particular methodology, protocols, etc., described herein, as these may vary as the skilled artisan will recognize. It is also to be understood that the terminology used herein is used for the purpose of describing particular embodiments only, and is not intended to limit the scope of the invention. For example, although certain embodiments including control devices and functionality included in smartphone and the like may be described for convenience, the invention may include similar control devices without limitation to smartphones or other specifically described devices. It also is to be noted that as used herein and in the appended claims, the singular forms “a,” “an,” and “the” include the plural reference unless the context clearly dictates otherwise. Thus, for example, a reference to “an icon” is a reference to one or more icons and equivalents thereof known to those skilled in the art.

As used herein, an “icon” may be understood generally as a pictogram or other symbol, shape, menu element, etc. displayed on a screen and used to navigate a control interface such as on a computer system, a remote control, gaming system, mobile device, etc. In the context of touch interfaces, icons may be activated, for example, by touching a corresponding location on a touch display, by touching a location on a touch pad that is linked to a separate display, and/or by moving a display cursor via a touch pad and “clicking” the icon via the touch pad or other button.

Unless defined otherwise, all technical terms used herein have the same meanings as commonly understood by one of ordinary skill in the art to which the invention pertains. The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals reference similar parts throughout the several views of the drawings.

As mentioned above, an example embodiment of a control device is described herein as a smartphone having a touch interface and a software application operating on the smartphone to control remotely located appliances and/or applications/services operating on those appliances. However, the various smartphone embodiments described herein are not limiting on the claims or the scope and purview of the present invention. For example, a control device as described herein may be a universal remote control, a keyboard, a tablet, or the like and may include the touch interface and the software applications described for executing the method of the present invention.

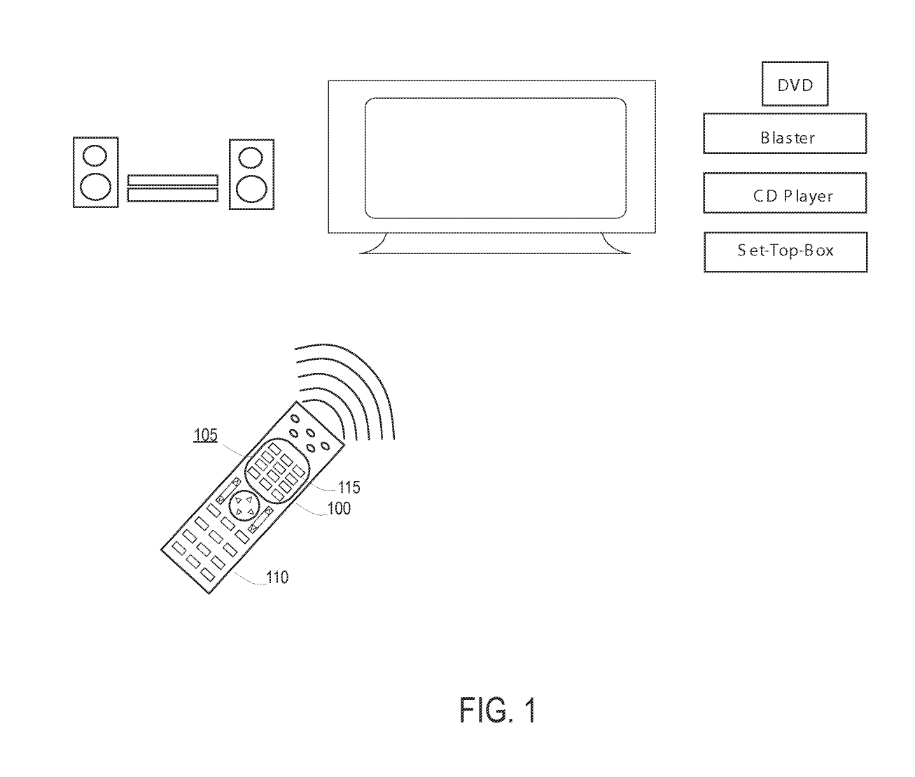

FIG. 1 is a simplified schematic of a control device 100 (e.g., a smartphone 100) according to one embodiment of the present invention. Example smartphones include the iPhone™ of Apple Inc., the Droid™ of Motorola Inc., etc. According to an alternative embodiment, the control device is a personal digital assistant, an iPad Touch™, a universal remote control, etc.

Smartphone 100 includes a touch interface 105, which includes a plurality of soft buttons 115. Soft buttons are well known in the art and include touch sensitive regions on the touch interface. Soft buttons typically include graphics, such as icons, that typically resemble traditional “click” buttons. Soft buttons are activated via a touch of the soft buttons, and may serve as, for example, an electronic hyperlink or file shortcut to access a software program or data. According to one embodiment, smartphone 100 includes a set of traditional click buttons 110 as well. A set as referred to herein includes one or more elements. The smartphone is configured to transmit various command codes (e.g., remote control command codes) for controlling a plurality of appliances and/or for controlling application/services operating on those appliances. The plurality of appliances may include entertainment devices, such as a TV, a DVR (digital video recorder), a DVD player, a receiver (such as a set-top-box), a CD player, etc. An entertainment device might also include a computer or another device (e.g., a gaming console, a set-top-box, etc.) operating a browsers, or a media application, such as iTunes™ where the control device is configured to control iTunes™ (e.g., volume up/down, media selection, etc.) by controlling the computer. Other examples of applications/services include Hulu™, Netflix™, etc.

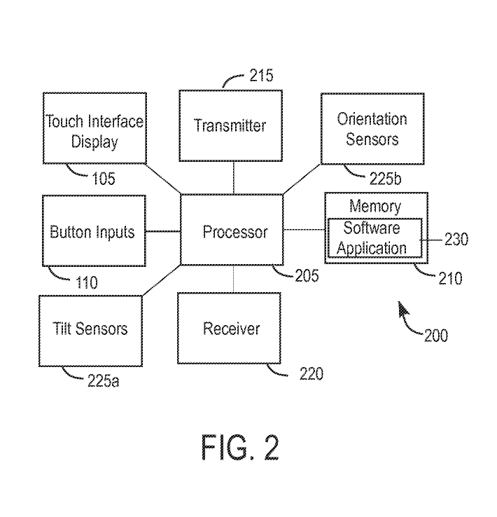

FIG. 2 is a simplified schematic of an electronic circuit 200 that is included in smartphone 100 in accordance with an embodiment of the invention. The electronic circuit shown in FIG. 2 is exemplary and other embodiments of control device 100 may not include all of the electronic components of electronic circuit 100, or may include additional or substitute electronic components. According to the embodiment of FIG. 2, electronic circuit 200 includes a processor (or alternatively a controller) 205, a memory 210, a set of transmitters 215, a set of receivers 220, touch interface 105, and the set of traditional click buttons 110. Processor 205 may be coupled to memory 210 for retrieving and storing code for the software application, for retrieving and storing command codes, for retrieving and storing timing information for the transmission of a set of command codes, and the like. Processor 205 is coupled to the touch interface 105 for controlling the displaying of soft buttons on the touch interface, and for receiving selections of the soft buttons by a user. The processor 205 is also coupled to the set of transmitters 215 and the set of receivers 220. The set of transmitters 215 may include wired and/or wireless transmitters, such as for USB transmissions, IR transmissions, RF transmissions, optical transmissions, etc. The set of receivers 220 may includes wired and/or wireless receives, such as for USB transmission, IR transmissions, RF transmissions, optical transmissions, etc. One or more of the transmitters and receivers may be transceiver pairs.

According to one embodiment, electronic circuit 200 includes a set of tilt sensors 225a, set of orientations sensors 225b, etc., which are coupled to the processor 205. The tilt sensors and/or orientation sensors may be one or more of a set of accelerometers, a compass application, and a gyroscope application. The compass application and/or the gyroscope applications may use GPS signals, cellular communication signals, the magnetic field lines of the earth, or other signals to determine an orientation of the smartphone in space. The tilt sensors and/or the orientation sensors are configured to detect a relatively “quick” shake of the control device, as well as distinguish between two or more movement-based indications that can signal, for example, different blind navigation modes to be activated. For example, a user may desire to have a first blind navigation mode for controlling an application of the smartphone, such as an audio player, and a second blind navigation mode for controlling a separate appliance, such as a TV. The first and second blind navigation modes may include separate and distinct commands from one another, as set by the user and/or dictated by the application or device to be controlled. The user may therefore, configure the smartphone 100 with one movement-based indication to launch the first blind navigation mode and a different movement-based indication to launch the second blind navigation mode.

In embodiments, a control device, such as smartphone 100 and others, may be configured to enable a second user interface based on, for example, an input from an icon, a push button, a touch interface and/or combinations thereof. For example, a designated push button or combination of buttons may be used to enable the second user interface. In embodiments, a single icon, or other input element, may be used to switch between interfaces and may be operable, for example, in both interfaces, e.g. an icon that is displayed in a portion of the touch display that remains enabled in the first and second user interfaces.

In accordance with an embodiment of the present invention, the smartphone 100 includes a software application 230 stored in memory 210 and executed by processor 205 that operates in conjunction with the touch interface 105. For example, the software application 230 may be a software application operable on the smartphone 100 for remotely controlling a set of appliances. While the term software application is used herein, the term software application includes firmware or a combination of firmware and software.

In another embodiment, software application 230 resides on an external device, such as a remote server, a host computer, a blaster, a set-top box, a gaming console, or the like, with which the control device is configured to communicate via a network or directly. A direct communication may be communicated via IR, RF, optical, wired link, etc. According to the embodiment in which the control device communicates with the external device (e.g., remote server, a host computer, a blaster, etc.) running the software application over a network, the network may be a local network (e.g., a LAN, a home RF network, etc.) or any other type of network such as a WiFi network (e.g., a link through a local wireless router), a cellular phone network, etc. A WAN may include the Internet, the Internet 2, and the like. A LAN may include an Intranet, which may be a network based on, for example, TCP/IP belonging to an organization accessible only by the organization's members, employees, or others with authorization. A LAN may also be a network such as, for example, Netware™ from Novell Corporation (Provo, Utah) or Windows NT from Microsoft Corporation (Redmond, Wash.). Network 320 may also include commercially available subscription-based services such as, for example, AOL from America Online, Inc. (Dulles, Va.) or MSN from Microsoft Corporation (Redmond, Wash.). Network 320 may also be a home network, an Ethernet based network, a network based on the public switched telephone network, a network based on the Internet, or any other communication network. Any of the connections in network 320 may be wired or wireless.

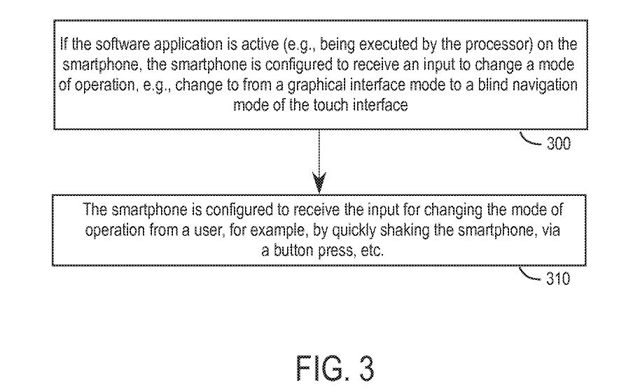

FIG. 3 is a high-level flow chart for a method for changing a mode of operation of a control device, in this case a smartphone, according to one embodiment of the present invention. The high level flow chart is exemplary and not limiting on the claims. Various steps shown in the flow chart may be added, removed, or combined without deviating from the purview and scope of the instant described embodiment. According to one embodiment, if the software application is active (e.g., being executed by the processor) on the smartphone, the smartphone is configured to receive an input to change a mode of operation (step 300), e.g., change from a graphical interface mode to a blind navigation mode of the touch interface. In one embodiment, the smartphone is configured to receive the input for changing the mode of operation from a user, for example, by quickly shaking or orienting the smartphone in a particular way, by swiping the touch screen in a predetermined way, via a button press, etc. (step 310).

The software application may be configured to monitor the orientation of the smartphone and a change in the orientation of the smartphone may initiate a mode change by the smartphone. Changes to the orientation of the smartphone may be made by the software application by monitoring the set of tilt sensors 225a and/or the set of orientations sensors 225b. More specifically, if the software application determines (by monitoring the tilt sensors and/or the orientation sensors) that the smart phone has been placed in a predetermined orientation or has been moved in a predetermined path (also referred to as a gesture), the software application is configured to change the mode of operation of the smart phone (e.g., change the mode of the smartphone from the graphical interface mode to the blind navigation mode). The software application may be configured to use the acceleration data, the tilt data, and/or the orientation data generated by the set of tilt sensors and/or the set of orientations sensors to determine a gesture through which the smart phone is moved to determine whether the gesture is a predetermined gesture associated with a mode change, a set of command codes or the like. The device may be configured such that the blind navigation activation may be enabled and disabled in various ways. For example, in situations where the user expects to use blind navigation, such as when watching TV, a first command may be given to the device, e.g. a hard button, that enables blind navigation when the appropriate indication is received. Likewise, when the user wants to disable blind navigation, such as when playing a game on a smartphone that might inadvertently activate blind navigation, a hard button or other command can be given to prevent the device from entering the blind navigation mode.

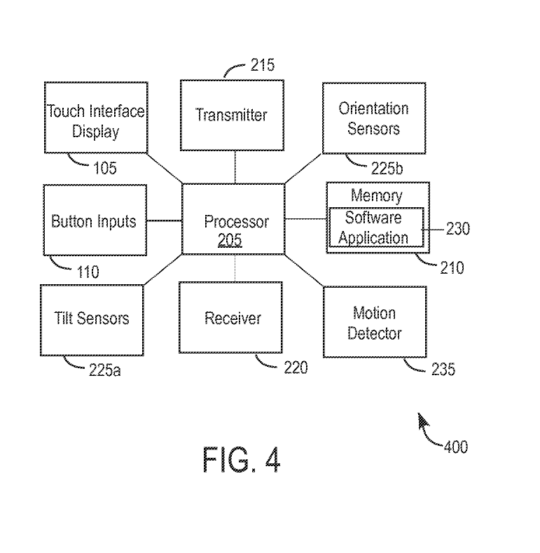

FIG. 4 is a simplified schematic of an electronic circuit 400 that is included in smartphone 100 according to an alternative embodiment of the present invention. Electronic circuit 400 differs from electronic circuit 200 in that electronic circuit 300 includes a motion detector or an image sensor 235. The motion detector might be a digital camera, such as a CMOS camera, a CCD camera, or the like. The motion detector is configured to detect a gesture of an object, such as a hand or finger, moved within the detection range of the motion detector. The software application is configured to monitor the motion detector to determine whether the motion detector has detected motion of an object where the motion is a predetermined gesture. As discussed above with respect to other gestures (swipe across the touch interface or motion of the smartphone), gestures detected by the motion detector may be mapped to specific functions of the smartphone, such as mode changes, application commands, etc., or associated with sets of command codes that may be transmitted from the smart phone to control a set of appliances. In some embodiments, switching to or from a graphical interface mode from or to a blind navigation mode, may be initiated by input provided to an image sensor and/or a motion detector.

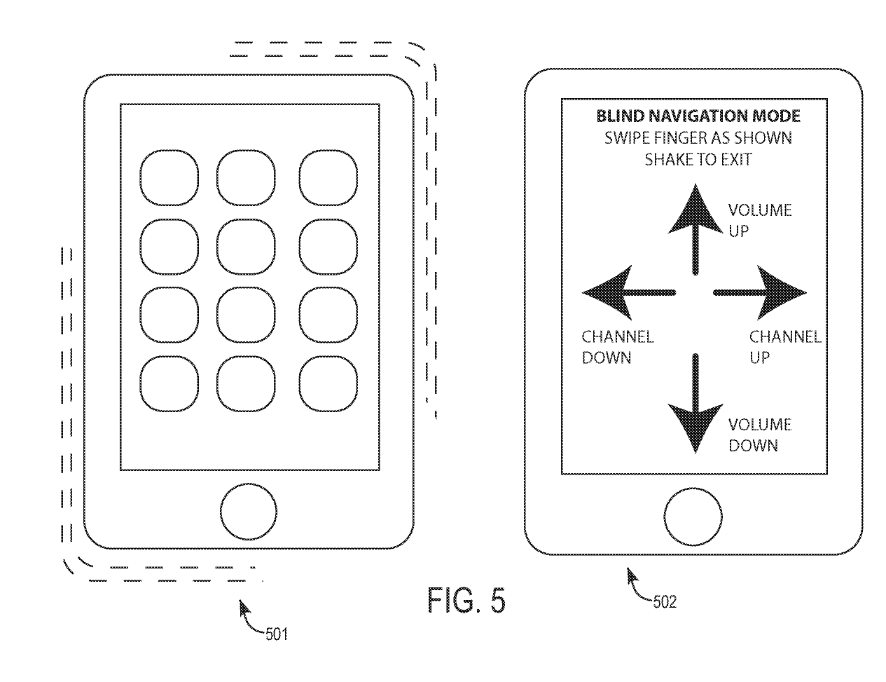

FIG. 5 shows further details of an embodiment of the invention as applied to a particular control device. As shown in FIG. 5, a control device may include a first user interface 501 including a plurality of icons, representing separate applications, commands, etc., that are selectable by touching corresponding portions of the touch display interface. First user interface 501 may also be responsive to one or more gestures, such as page swipes, etc. The control device may include any number of hard buttons (not shown) as well. When the device detects an indication to change the first user interface to a blind navigation mode, such as detecting a shaking of the device, selection of a designated icon, a designated touch gesture, a hard button press, etc., the touch display interface may be reconfigured to display, for example, a second user interface 502 with a plurality of commands, which may be different than those available through first user interface 501, or which may employ different touch gestures than commands of the first user interface 501. For example, the commands included in second user interface 502 may be remote control commands such as volume and/or channel adjustment controls with different corresponding touch movements. The second user interface 502 may be configured to receive and/or recognize touch movements and/or combinations of touch movements, rather than selections of particular icons.

By way of further example, a certain gesture usable in the first user interface 501, may perform different functions in the second user interface 502, e.g. a page swipe may navigate between different pages of icons in first user interface 501, and may instruct a command to execute or transmit a different function, such as a channel up, etc., in the second user interface 502. It should be noted that, in some embodiments, the second user interface 502 may be enabled on a non-display touch interface, or in only a portion of the touch screen area thereby continuing to allow access to one or more icons and/or commands from the first user interface in another portion of the screen. For example, a switching icon in first user interface may enable the second user interface in a portion of the screen, and the switching icon may remain operable while the second user interface is enabled.

Any number of blind navigation interfaces may be implemented and may include different blind navigation interfaces for different devices and/or applications, that may be initiated by different indicators. In an embodiment of the invention, the detection of a gesture may trigger a switch from a graphical interface mode to blind navigation mode or the reverse. The gesture may be detected via an image sensor, motion detector or otherwise.

The second user interface 502 shows instructions on screen such that users not familiar with the blind navigation interface can easily determine what gestures are available and deactivate the interface when desired. However, it should be noted that other embodiments may reconfigure the touch display without changing what is displayed on the device or only partially changing the display. For example, reconfiguring the touch display may involve only reconfiguring the command recognition module of the device's control application to be responsive to the blind navigation commands, or it may involve changing a portion of the display in which blind navigation commands may be input, e.g. displaying a window in which blind navigation commands will be recognized. In the embodiment shown in FIG. 5, swipe commands may be detected throughout the entire touch screen, e.g. any up, down, or side to side swipe across the screen may be recognized as corresponding to a command of the second user interface 502. In embodiments, a visual, tactile and/or audio alert may be provided indicating that the second user interface has been activated.

In embodiments, the second user interface 502 may include touch movement commands that correspond to command controls of icons from the first user interface 501. For example, first user interface 501 may include a plurality of icons with associated command functions for controlling a set of separate appliance such as a A/V system. One set of the icons included in first user interface 501 may therefore be, for example, volume controls. However, a user may not need access to all of the available commands in the blind navigation mode. Therefore, the second user interface 502 may include touch movement commands corresponding to a subset of the available commands shown in first user interface 501. Thus, the touch screen interface may be reconfigured to disable all of the icons from first user interface 501 and to enable a touch movement command in the second user interface 502 that corresponds to a command function of one or more of the disabled icons (e.g. a volume control, a channel control, etc.).

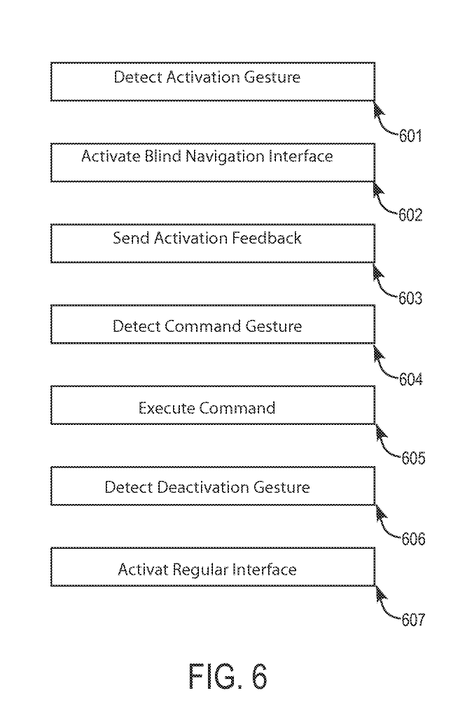

FIG. 6 is a detailed flow chart showing a method of an embodiment of the invention. Various steps shown in the flow chart may be added, removed, or combined without deviating from the purview and scope of the invention. According to an embodiment, an activation gesture is detected in step 601, and the blind navigation interface is activated in step 602 and feedback is sent to the user in step 603. The gesture may be a shake of the device, a screen gesture, a physical gesture detected by a camera, or any other activation gesture. The feedback to the user may, for example, include vibrating the device, a sound notification or dimming or flashing the screen. Once the blind navigation user interface is detected, a command gesture may be detected in step 604. A command gesture may, for example, include a swipe of a finger from the top of the screen to the bottom of the screen, a swipe pattern, a swipe in a designated area of the touch display, etc. The command gesture may correspond to a particular command, such as decreasing sound volume.

In embodiments, detected command gestures may be confirmed to the user by providing visual, tactile and/or audio confirmation. The confirmation may be unique to the recognized command and may thereby confirm to the user that the intended command has been recognized. For example, an audio phrase may be emitted such as “volume up” or “volume down” so that the user knows what command has been recognized. Alternative tactile feedback may also include, for example, different vibration cycles for different commands, etc.

Once recognized, the particular command may be executed in step 605 and/or transmitted to another appliance as described herein. It should be noted that, according to embodiments, commands may be indirectly routed to the commanded device(s) via intermediary devices such as, for example, a blaster, a Logitech Harmony® link, or other linked device such as an A/V receiver. Thus, for example, a command for an appliance, such as a DVD player, may be transmitted by the control device to a linked device, such as a TV, and retransmitted by the linked device to the appliance. In embodiments, the particular command may be related to an application currently running on the control device, e.g. a video or audio player, and the command may be executed by the running application. This may be advantageous, for example, in allowing the user to easily adjust certain settings, such as volume, brightness etc., via the touch screen without interrupting the running application. Step 605 may include activating a macro on the device or sending a particular infrared code.

Once a deactivation gesture is detected in step 606 the blind navigation interface may be deactivated and the regular interface activated in step 607. The de-activation gesture may be a shake of the device, a screen gesture, or any other de-activation gesture.

While the foregoing describes changing the mode of operation from the graphical interface mode to the blind navigation mode if the smartphone is moved according to a specific gesture, the specific gesture might be a toggle function and switch between modes based on the current mode of the smartphone. For example, if the smartphone is moved according to a specific gesture (e.g., in a circle motion), then the software application may be configured to put the smartphone in the blind navigation mode if the smartphone is in the graphical interface mode, or alternatively, if the smartphone is in the graphical interface mode the software application may place the smart phone in the blind navigation mode.

According to a further embodiment of the present invention, the software application may be configured to determine the types of sensors that a given control device includes. For example, the software application might be an “aftermarket” application that may be purchased independently of the control device as an “aftermarket” product. Alternatively, the software application might be a “native” application that is provided with a control device at the time of purchase. According to one embodiment, the software application may be configured to determine whether a control device has a set of tilt sensors, a set of orientations sensors, or the like. Based on whether a given control device includes a set of tilt sensors, orientations sensors, or the like, the software application may be configured to present on the touch interface or otherwise the types of gestures that are available to a user for assigning to mode changes, sets of commands codes, and the like. Generally, if a control device includes a set of tilt sensors, but not a set of orientation sensors, the number and types of gestures available for use on the control device will be fewer than the number and types of gestures available on a control device having both a set of tilt sensors and orientations sensors. For example, the software application may be configured to present a first set of available gestures for the user to select from based on a first set of detected sensors, and to present a second set of available gestures for the user to select from based on a second set of detected sensors and/or combinations of sensors.

According to another embodiment, the mode of operation of the control device may be changed via the software application monitoring the touch interface for the receipt of a particular gesture/swipe of a finger, stylus, etc. (e.g., a circular swipe on the touch interface). In an alternative mode, the software application does not need a specific entry by a user to enter the blind navigation mode to enable blind navigation, and may be based on, for example, ambient conditions such as light and/or short-range communication signals. According to one embodiment, the control device includes a light sensor and if a predetermined level of “low” light is detected by the light sensor, the software application is configured to put the control device in the blind navigation mode. If light of light above the low light level is detected by the light sensor, the software application may put the control device in the graphical interface mode. This may be advantageous, for example, when the user is watching TV in a dimmed room, or in activating a blind navigation mode at night while the user sleeps, allowing the user to intuitively access desired commands and/or applications if awakened during the night, etc. Alternatively, a predetermined signal may activate the blind navigation mode such as a Bluetooth signal associated with a user's vehicle etc. Such features may be used as safety measures to, for example, disable certain functions of a smartphone and the like when operated in a vehicle or aircraft. In an embodiment of the invention, the user may be able to configure and/or reconfigure how a mode of operation is activated and/or deactivated, e.g. by selecting a particular gesture for activating and deactivating a mode, etc.

In one embodiment, after the device is placed in the blind navigation mode, blind navigation via the touch interface is enabled. In the blind navigation mode the software application may be configured to recognize a plurality of gestures of one or more a fingers, hands, a styluses, or the like on the touch interface. A gesture may include a movement of a finger or a plurality of fingers, a stylus, or the like across the touch interface. Each pre-defined gesture may be associated with a set of specific command codes, which may be executed by the device, and/or transmitted from the device for controlling one or more appliances/applications/services etc. In an embodiment of the invention, the touch screen displays indications of the appliance or application to be controlled and/or possible gestures on screen to indicate to the user which gestures are recognized and what commands they correspond to, such that a user can identify what is being controlled, and those users not familiar with the gestures can quickly become familiar with the recognized gestures. The possible gestures displayed may be based, for example, on an application currently running on the control device, e.g. a movie or audio player.

In embodiments, a gesture may be defined by a user and associated with a set of command codes. A set of commands codes may include a single command code, such as for changing an input on a TV (e.g., change input from HDMI 1 to component 1), changing the volume etc., or it may include a plurality of commands codes for performing an action. An action may include a plurality of command codes for a watch DVD action, a listen to CD action, a watch TV action, etc. A watch TV action might include command codes for turning on the TV, setting the input for the TV to the component 1 input for the set-top-box, and turning on the set-top-box. The watch TV action might include one or more additional command codes, such as a command code for turning the set-top-box to the user's favorite TV channel (e.g., channel 6). According to one embodiment, the touch interface may be configured to detect incremental motion for controlling an appliance and/or an application/service operating on an appliance, such a incrementally increasing the volume of a media application operating on a computer.

In one embodiment, it is to be noted that different functions/command codes may be sent by the software application on the control device (e.g., remote control, smartphone, etc.) to different appliances or different applications. For example, from a single blind navigation mode, a volume control command may be directed at an audio receiver on a set-top-box, a TV, etc., while page up/down commands may be directed at a browser application operating on a computer. In one embodiment, the user is able to specify which commands are directed to which appliances/applications.

According to one embodiment, the control device is configured to remember and update the states of a set of appliances, such as remember the volume setting of a TV, the input of the TV (e.g., HDMI 2 input), the power on state of the TV and the set-top-box, and the state of a surround sound system. U.S. Pat. No. 6,784,805, titled “State-Based Remote Control System,” of Glen McLean Harris et al., the contents of which are incorporated herein by reference in their entirety, discusses a remote control and remote control system configured to remember and update stored states of controlled appliances and is incorporated by reference herein. According to one embodiment, the control device, or a different device (e.g. an IR blaster), may be configured to change one or more command codes in a set of command codes to direct a specific appliance to perform a function instead of a given appliance. For example, if the control device includes stored states that indicate that the surround sound system is controlling the volume for a movie being played on the TV, the control device might remove a command code from a set of commands codes for a “Watch TV” action (e.g., a macro) for setting the volume of the TV, and might replace the command code for setting the volume on the TV with a command code for setting the volume on the surround sound system. The initial “Watch TV” action might be assigned to a specific touch gesture on the touch interface.

According to embodiments, sets of commands codes that are commonly executed may be mapped to specific gestures on a touch interface. Commonly executed set of commands codes may include, for example, Play, Pause, fast forward (FWD), rewind (RWD), volume up, volume down, mute, page up, page down, channel up, channel down, watch TV, watch a DVD, play a CD, and so on. For instance, in one embodiment, a single swipe of a finger up on the touch interface may correspond to a discrete increase volume command code. A single swipe of a finger down on the touch interface may correspond to a discrete decrease volume command code. A single swipe up of a finger on the touch pad followed by the finger being held may correspond to a plurality of increase volume command codes. A single swipe of a finger down on the touch interface followed by the finger being held down on the touch interface may correspond to a plurality decrease volume command codes.

In one embodiment, D-pad up, D-pad down, D-pad left and D-pad right command codes may be mapped to gestures. In one embodiment, a single swipe may be mapped to a discrete D-pad command, whereas a single swipe followed by holding the finger down may send multiple D-pad commands. The directions of the swipes (e.g., left, right, angled, circular, etc.) are unique for each command code according to one embodiment of the present invention.

In embodiments, the user may be allowed to specify what gestures are recognized when the device is in blind-mode. In an embodiment of the invention, the user can access a menu to specify what gestures correspond to individual commands when the device is in blind-mode. The available gestures provided may depend, for example, on actual sensors that have been detected in the device. Furthermore, the user may be able to specify more than one blind mode, wherein each mode is activated in a different manner. For example, the first blind mode may allow the user to change the channel of a television set by swiping up or down. The second blind mode may allow the user to change the volume by using the same gesture to swipe up or down.

It is to be noted that the gestures/swipes mentioned herein may include a single finger touch of the touch interface, and/or multiple fingers touching the touch interface. Different functions may be mapped to sets of command codes, depending not only on the gesture, but also on the number of fingers touching the touch interface. For instance, in one embodiment, a single swipe up (or down) may be mapped to a discrete line scroll up (or line scroll down) command code. In one embodiment, a single swipe followed by holding the finger down may send multiple line scroll command codes, or to continue to execute a volume control command and the like. In one embodiment, swiping using a single finger applying a second finger may send page up/down commands (rather than a single line scroll-up or single line scroll-down command codes), thus providing an acceleration algorithm. Alternately, swiping using two fingers may send page-up command codes or page-down command codes. Another example is to map a swipe of one finger to cursor movements command codes, and map a swipe using two fingers to a scroll command. In one embodiment a movement of the entire device may be mapped to a set of commands. It is to be noted that particular implementations/mappings of gestures/swipes/shakes/movements to the commands is virtually unlimited.

As described herein, blind navigation modes of the control device may allow a user to intuitively perform myriad control functions through gestures or swipes onto the touch interface and/or by movement of the control device without diverting his attention from the task at hand (e.g., watching the TV screen).

According to one embodiment of the present invention, the control device includes a haptic feedback module. The haptic feedback module may be configured to vibrate the touch interface, the entire control device, etc. In one embodiment, the various gestures/swipes on the touch interface are detected by the software application and are thereby configured to cause the haptic feedback module to vibrate the touch interface, the entire control device, etc. For instance, in one embodiment, a haptic feedback (e.g., a vibration) may inform the user that blind navigation has been enabled, or that a secondary blind navigation mode has been enabled. In another embodiment, haptic feedback indicates to the user that the desired function/command code has been transmitted from the control device to the appliance (e.g., TV, set-top box, etc.).

In yet another embodiment, the appliance being controlled by the control device provides confirmation to the control device that the function/command code has been implemented by the device being controlled, and haptic feedback from the haptic feedback module provides this information to the user. In yet another embodiment, haptic feedback indicates to the user that the command has not been transmitted by the control device, and needs to be re-sent.

According to another embodiment of the invention, sound or light may be used to provide feedback to the user. For example, the device may beep once, flash the screen once or dim or otherwise alter the screen, to indicate that blind navigation mode is enabled.

While particular embodiments and applications of the present invention have been illustrated and described, it is to be understood that the invention is not limited to the precise construction and components disclosed herein. Various other modifications, changes, and variations which will be apparent to those skilled in the art may be made in the arrangement, operation and details of the method and apparatus of the present invention disclosed herein, without departing from the spirit and scope of the invention as defined in the following claims.

What is claimed is:

1. A computer-implemented method of enabling blind navigation of a control device having a touch display interface, the method comprising:
presenting a first user interface on the touch display interface, the first user interface including an icon selectable by touching a designated portion of the touch display interface;
receiving an indication that the control device is to enable a second user interface;
reconfiguring the touch display interface to receive a set of commands, corresponding to the second user interface, including one or more touch movements on the touch display interface;
receiving a touch movement input via the touch display interface;
determining a command, from among the set of commands, to which the received touch movement input corresponds; and
at least one of executing and transmitting the command.

2. The computer-implemented method of claim 1, wherein the control device is at least one of a smartphone, tablet, touch enabled display device, and a remote control.

3. The computer-implemented method of claim 1, wherein the command is transmitted by the control device to a separate appliance via at least one of an IR link, and RF link, and a network link.

4. The computer-implemented method of claim 1, wherein the indication that the control device is to enable a second user interface is provided by an ambient source.

5. The computer-implemented method of claim 1, wherein the step of determining a command to which the received touch movement input corresponds comprises comparing the received touch movement input to a plurality of pre-specified inputs, wherein each of the plurality of pre-specified inputs is mapped to a command.

6. The computer-implemented method of claim 1, wherein the command is transmitted to an entertainment device.

7. The computer-implemented method of claim 1, wherein reconfiguring the touch screen interface includes disabling the icon and enabling a touch movement command in the second user interface that corresponds to a command function of the icon.

8. The computer-implemented method of claim 1, wherein the step of receiving an indication that the control device is to enable the second user interface comprises receiving a predetermined input based on information from at least one of a tilt, motion and orientation of the control device.

9. The computer-implemented method of claim 1, further comprising providing a user feedback based on the determining of the command to which the received touch movement input corresponds, wherein the user feedback includes at least one of a device vibration, an audio signal, and a visual signal.

10. The computer-implemented method of claim 1, wherein reconfiguring the touch screen interface includes enabling a portion of the touch display interface to respond to touch movement commands in the second user interface.

11. A control device comprising:
a touch display interface;
a microprocessor; and
computer-readable storage medium with program instructions executable by the microprocessor, which configure the microprocessor to:
present a first user interface on the touch display interface, the first user interface including an icon selectable by touching a designated portion of the touch display interface;
receive an indication that the control device is to enable a second user interface;
reconfigure the touch display interface to receive a set of commands, corresponding to the second user interface, including one or more touch movements on the touch display interface;
receive a touch movement input via the touch display interface;
determine a command, from among the set of commands, to which the received touch movement input corresponds; and
at least one of execute and transmit the command.

12. The control device of claim 11, wherein the control device is included in at least one of a smartphone or a tablet.

13. The control device of claim 11, wherein the device is configured to provide a user feedback based on the determining of the command to which the received touch movement input corresponds.

14. The control device of claim 13, wherein the user feedback indicates the determined command in a manner that is distinguishable from other possible commands.

15. A computer-implemented method of enabling blind navigation of a control device having a touch interface, and at least one of a tilt sensor, an orientation sensor, and a motion sensor, the method comprising:
enabling a first user interface on the control device, the first user interface including a first set of commands that can be activated by touching the touch interface;
receiving an indication via at least one of the tilt sensor, the orientation sensor and the motion sensor that the control device is to enable a second user interface wherein the second user interface includes a second set of commands configured to be receptive to at least one touch gesture on the touch interface;
enabling the second user interface;
receiving a touch gesture input via the touch interface;
determining a command, from among the second set of commands, to which the received touch gesture input corresponds; and
at least one of executing and transmitting the command.

16. The method of claim 15, wherein the indication is received via a plurality of orientation sensors.

17. The method of claim 15, wherein the indication is at least one of a gesture through which the control device is moved and a gesture detected by the motion detector.

18. The method of claim 15, wherein the indication is a shake of the control device.

19. The method of claim 15, wherein a particular movement of the device that initiates the indication is set by a user.

20. The method of claim 15, wherein:
the first user interface includes at least one of:
a command gesture that performs a selected function included in both of the first user interface and the second user interface, using a different gesture than the second user interface uses for the first selected function; and
a command gesture that performs a selected function of the first user interface, using a same gesture that is also used by the second user interface for a different function than the selected function.
